(19) United States
(12) Patent Application Publication
(10) Pub. No.: US 2026/0109029 A1
(43) Pub. Date: Apr. 23, 2026

(54) MODEL PREDICTIVE CONTROL WITH LEARNED VALUE FUNCTIONS FOR ROBOT GRASPING

(71) Applicant: NVIDIA CORPORATION, Santa Clara, CA (US)

(72) Inventors: Balakumar SUNDARALINGAM, San Jose, CA (US); Ajay Uday MANDLEKAR, Cupertino, CA (US); Adithyavairavan MURALI, Seattle, WA (US); Jun YAMADA, Oxford (GB)

(21) Appl. No.: 19/359,492

(22) Filed: Oct. 15, 2025

Related U.S. Application Data
(60) Provisional application No. 63/709,967, filed on Oct. 21, 2024.

(51) Int. Cl. B25J 9/16

(52) U.S. Cl. CPC B25J 9/163; B25J 9/161; B25J 9/1612; B25J 9/1651; B25J 9/1697

(57) ABSTRACT

One embodiment of a method for controlling a robot includes computing, using a trained machine learning model and based on sensor data, one or more costs associated with one or more trajectories; determining an action based on the one or more costs; and controlling the robot to move based on the action.

### CROSS-REFERENCE TO RELATED APPLICATIONS

This application claims priority benefit of the U.S. Provisional Patent Application titled, “TECHNIQUES FOR INTEGRATING LEARNED VALUE FUNCTIONS INTO MODEL PREDICTIVE CONTROL FOR ROBOT GRASPING,” filed on Oct. 21, 2024, and having Ser. No. 63/709,967. The subject matter of this related application is hereby incorporated herein by reference.

### BACKGROUND

### Technical Field

Embodiments of the present disclosure relate generally to computer science, machine learning and artificial intelligence, and robotics and, more specifically, to model predictive control with learned value functions for robot grasping.

### Description of the Related Art

Robots are being increasingly used to perform tasks automatically in various environments. In many automated applications, one task that a robot has to be controlled to perform is grasping an object. For example, in a factory setting, a robot could be controlled to grasp an object being manufactured prior to moving the object or otherwise interacting with or performing operations on the object.

One conventional approach for controlling a robot to grasp an object, referred to as open-loop planning, divides the grasping task into two separate steps. The first step involves detecting the position of the object that the robot needs to grasp. The second step uses a motion planning technique to compute a path that starts from the current position of the robot and ends at the position of the object. Once that path is determined, the robot is controlled to move along the determined path and grasp the object.

One drawback of the above approach is the inability of open-loop planning to adapt to changes in real time. For example, if the path computed during open-loop planning moves the gripper of a robot to a position from which the gripper is incapable of grasping an object, open-loop planning cannot adjust the path in real time to move the gripper to a more suitable position. Instead, open-loop planning requires the entire path to be followed, after which another path can be computed if the original path was not successful in grasping the object. As another example, open-loop planning cannot recover in real time from errors in the camera calibration, incorrect detections of objects, movement of objects to other locations, or the like.

Another conventional approach for controlling a robot to grasp an object, referred to as closed-loop planning, uses a trained machine learning model, such as a neural network, to directly predict a pose of the robot required to grasp the object. Then, the robot is controlled to achieve the predicted pose.

One drawback of the above approach is that closed-loop planning typically only works in simplified settings, such as a clean table with a single object for the robot to grasp. In a cluttered environment that includes multiple different objects, closed-loop planning can fail to successfully control a robot to grasp an object. Another drawback of closed-loop planning is the inability to generalize across objects. In that regard, the machine learning model that predicts grasp poses in closed-loop planning can typically only predict correct poses for grasping the particular object that was used to train the machine learning model. The machine learning model cannot, as a general matter, be used to control a robot to grasp other types of objects.

As the foregoing illustrates, what is needed in the art are more effective techniques for controlling robots to grasp objects.

### SUMMARY

One embodiment of the present disclosure sets forth a computer-implemented method for controlling a robot. The method includes computing, using a trained machine learning model and based on first sensor data, one or more first costs associated with one or more first trajectories. The method further includes determining an action based on the one or more first costs. In addition, the method includes controlling the robot to move based on the action.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques can control a robot to grasp an object while adapting to changes in real time, including movements of the object. The disclosed techniques also permit robots to grasp objects in cluttered environments. Another advantage is that the grasp planning according to the disclosed techniques is generalizable across different types of objects, allowing a robot to be controlled to grasp various objects. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the value function of FIG. 1, according to various embodiments;

FIG. 5 is a more detailed illustration of the model trainer of FIG. 1, according to various embodiments;

FIG. 6 is a more detailed illustration of the robot control application of FIG. 1, according to various embodiments;

FIG. 7 is a more detailed illustration of the model predictive control module of FIG. 6, according to various embodiments;

FIG. 8 is a flow diagram of method steps for training a value function, according to various embodiments; and

FIG. 9 is a flow diagram of method steps for controlling a robot, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for integrating learned value functions into model predictive control for robot grasping. In some embodiments, a value function is a trained machine learning model that includes an object representation encoder, an object state encoder, and a multi-layer perceptron (MLP). Given a point cloud representation of an object (“object point cloud”) and a robot state as input, the object representation encoder encodes the object point cloud to generate a latent representation of the object, and the object state encoder encodes the robot state to generate a latent representation of the robot state. The latent representation of the object and the latent representation of the robot state are concatenated together and then input into the MLP, which outputs a predicted cost-to-go. The predicted cost-to-go can be used to compute the cost of trajectories in a model predictive control (MPC) technique that generates an action, and a robot can be controlled to perform the action. The foregoing process can be repeated to generate successive actions, until the robot is in position for grasping an object. The value function can be trained using training data that includes positive and negative examples that are generated by (1) generating motion plans for grasping objects based on known grasp poses, and (2) executing the motion plans in simulation to determine positive examples where an object was successfully grasped and negative examples where an object was not successfully grasped.

The techniques for controlling a robot that are disclosed herein have many real-world applications. For example, those techniques could be used to control a robot to grasp objects in various environments, such as manufacturing and assembly settings, warehouses, recycling and waste management facilities, etc. As another example, those techniques could be used to control a robot to perform other tasks, such as inserting an object into another object, opening a door, etc.

The above examples are not in any way intended to be limiting. As persons skilled in the art will appreciate, as a general matter, the techniques for controlling robots to grasp objects described herein can be implemented in any suitable application.

### System Overview

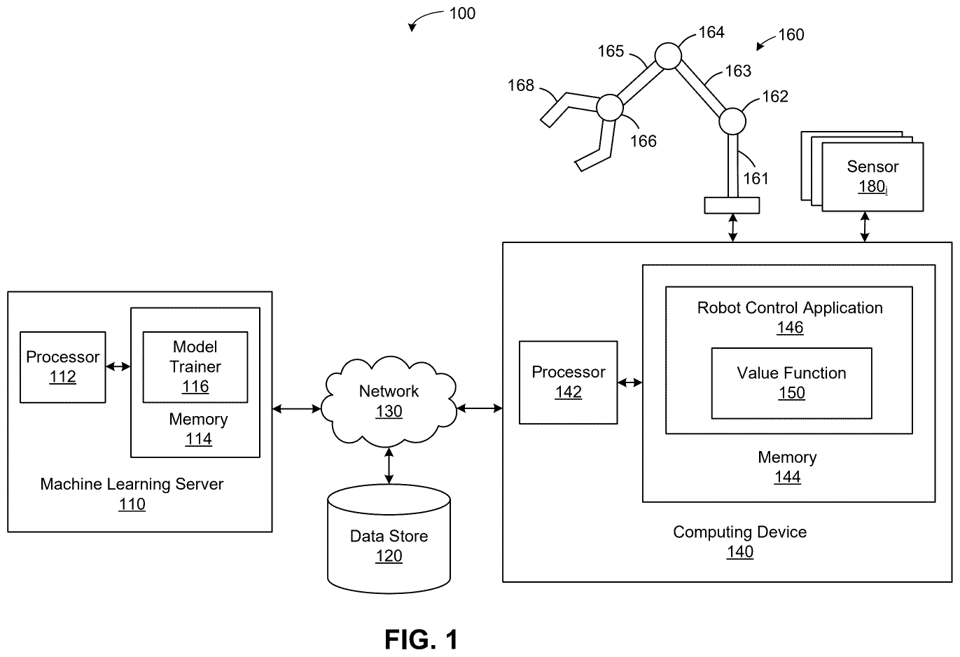

FIG. 1 illustrates a system 100 configured to implement one or more aspects of the various embodiments. As shown, the system 100 includes, without limitation, a machine learning server 110, a data store 120, and a computing device 140 in communication over a network 130, which can be a wide area network (WAN) such as the Internet, a local area network (LAN), or any other suitable network. The system 100 also includes a robot 160 and one or more sensors 180ᵢ (referred to herein collectively as sensors 180 and individually as a sensor 180) that are in communication with the computing device 140 (e.g., via a similar network). In some embodiments, the sensors can include one or more RGB (red, green, blue) cameras and optionally one or more depth cameras, such as cameras using time-of-flight sensors, LIDAR (light detection and ranging) sensors, etc. In addition, the machine learning server 110 includes, without limitation, a processor 112 and a system memory 114 (also referred to herein as “memory 114”), and the computing device 140 includes, without limitation, a processor 142 and a system memory 144 (also referred to herein as “memory 144”). The memory 114 of the machine learning server 110 includes, without limitation, a model trainer 116. The memory 144 of the computing device 140 includes, without limitation, a robot control application 146. The robot control application 146 includes, without limitation, a value function 150.

As shown, the model trainer 116 executes on the processor 112 of the machine learning server 110 and is stored in the memory 114 of the machine learning server 110. The processor 112 receives user input from input devices, such as a keyboard or a mouse. In operation, the processor 112 is the master processor of the machine learning server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The memory 114 of the machine learning server 110 stores content, such as software applications and data, for use by the processor 112 and the GPU. The memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the machine learning server 110 shown herein is illustrative and that variations and modifications are possible. For example, the number of processors 112, the number of GPUs, the number of system memories 114, and the number of applications included in the memory 114 can be modified as desired. Further, the connection topology between the various units in FIG. 1 can be modified as desired. In some embodiments, any combination of the processor 112, the memory 114, and a GPU can be replaced with any type of virtual computing system, distributed computing system, or cloud computing environment, such as a public, private, or a hybrid cloud.

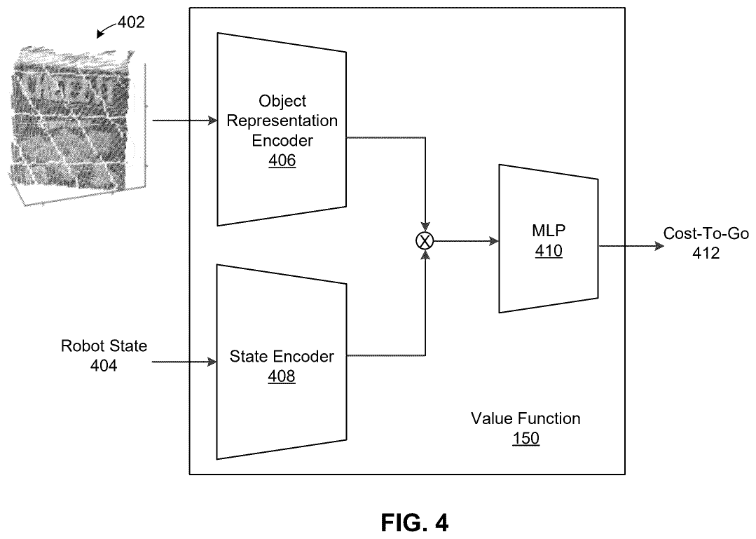

In some embodiments, the model trainer 116 is configured to train one or more machine learning models, including a value function 150. Given as input a point cloud representation of an object and a state of the robot 160, the value function 150 can generate a cost-to-go. The value function 150 and techniques for training the value function 150 are discussed in greater detail below in conjunction with FIGS. 4-5 and 8. Training data and/or trained machine learning models, including the value function 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the machine learning server 110 can include the data store 120.

As shown, the robot control application 146 that utilizes the value function 150 is stored in the memory 144, and executes on the processor 142, of the computing device 140. Once trained, the value function 150 can be deployed, such as via robot control application 146, for use in a model predictive control (MPC) technique to control the robot 160, given sensor data captured by the sensor(s) 180, as discussed in greater detail below in conjunction with FIGS. 4-6 and 9.

Illustratively, the robot 160 includes multiple links 161, 163, and 165 that are rigid members, as well as joints 162, 164, and 166 that are movable components that can be actuated to cause relative motion between adjacent links. In addition, the robot 160 includes a gripper 168, which is the last link of the robot 160 and can be controlled to grasp an object. Although an exemplar robot 160 is shown for illustrative purposes, techniques disclosed herein can be employed to control any suitable robot.

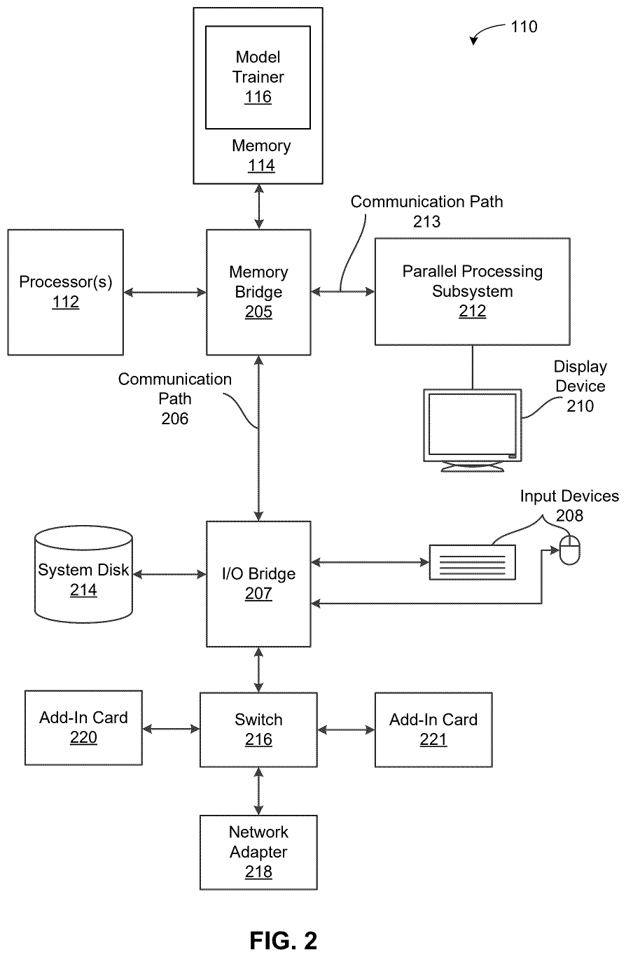

FIG. 2 is a block diagram illustrating the machine learning server 110 of FIG. 1 in greater detail, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network. In some embodiments, the machine learning server 110 can include one or more similar components as the machine learning server 110.

In various embodiments, the machine learning server 110 includes, without limitation, the processor(s) 112 and the memory (ices) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. Memory 114 includes at least one device driver configured to manage the processing operations of the one or more PPUs within parallel processing subsystem 212. In addition, the memory 114 includes the model trainer 116. Although described herein primarily with respect to the model trainer 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor(s) 112 and other connection circuitry on a single chip to form a system on a chip (SoC).

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, memory 114 could be connected to the processor(s) 112 directly rather than through memory bridge 205, and other devices may communicate with memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

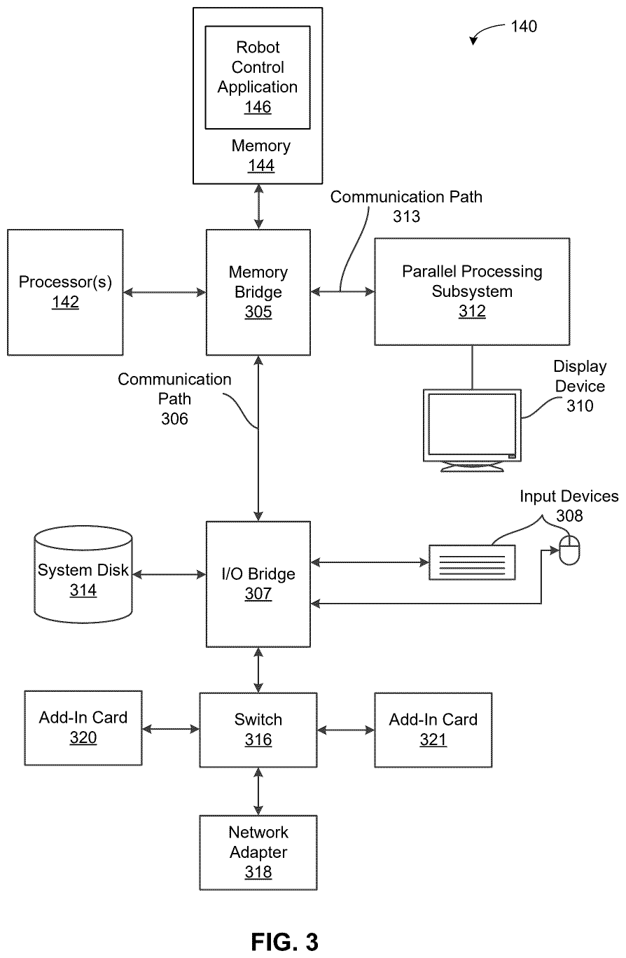

FIG. 3 is a block diagram illustrating the computing device 140 of FIG. 1 in greater detail, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network. In some embodiments, the machine learning server 110 can include one or more similar components as the computing device 140.

In various embodiments, the computing device 140 includes, without limitation, the processor(s) 142 and the memory(ies) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via the network adapter 318. In some embodiments, switch 316 is configured to provide connections between I/O bridge 307 and other components of the computing device 140, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a Northbridge chip, and I/O bridge 307 may be a Southbridge chip. In addition, communication paths 306 and 313, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations. Memory 144 includes at least one device driver configured to manage the processing operations of the one or more PPUs within parallel processing subsystem 312. In addition, the memory 144 includes the robot control application 146. Although described herein primarily with respect to the robot control application 146, techniques disclosed herein can also be implemented, either entirely or in part, in other software and/or hardware, such as in the parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, the processor(s) 142 issues commands that control the operation of PPUs. In some embodiments, communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 312, may be modified as desired. For example, in some embodiments, memory 144 could be connected to the processor(s) 142 directly rather than through memory bridge 305, and other devices may communicate with memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Controlling Robots Using Neural Implicit Value Functions

FIG. 4 is a more detailed illustration of the value function 150 of FIG. 1, according to various embodiments. As shown, the value function 150 includes, without limitation, an object representation encoder 406, a state encoder 408, and a multi-layer perceptron (MLP) 410. In some embodiments, the value function 150 is a trained machine learning model, such as a neural network.

In operation, the value function receives as input a point cloud representation of an object 402 (also referred to herein as “object point cloud 402”) and a robot state 404. The object point cloud 402 can be obtained in any technically feasible manner in some embodiments, such as by performing semantic segmentation on RGB-D (red, green, blue, depth) sensor data and extracting depths corresponding to a particular object identified through the semantic segmentation to create the object point cloud 402. In some embodiments, the robot state 404 is a state of the robot, such as a gripper pose, with respect to the object point cloud 402.

The object representation encoder 406 is a trained machine learning model, such as a neural network, that encodes the object point cloud 402 to generate a latent representation of the object.

The state encoder 408 is a trained machine learning model, such as a neural network, that encodes the robot state 404 to generate a latent representation of the robot state. The latent representation of the object and the latent representation of the robot state are concatenated together and then input into the MLP 410.

The MLP 410 is a trained machine learning model, such as a neural network, that processes the concatenated latent representation of the object and latent representation of the robot state and outputs a cost-to-go 412. The cost-to-go 412 is a predicted minimum cost to grasp the object representation by the object point cloud 402 from the robot state 404.

More specifically, the problem of grasping an object by a robot can be formulated as a Partially Observable Markov Decision Process (POMDP). A trajectory can be defined as τ=(xₜ, aₜ, cₜ, xₜ₊₁, aₜ₊₁, cₜ₊₁, . . . ), where x∈χ are observations, a∈ [symbol] actions, and c∈ [symbol] costs. Assume that an offline dataset includes N trajectories τⁱ^{^{N}}i=1, including both successes and failures. The objective is to minimize the discounted cumulative cost J(τ)=Σt′=t^{∞}γ^{t-t′}c(xₜ, aₜ), with discount factor γ. A large-scale grasp trajectory dataset generated in a simulation can be used to train the value function 150. Then, the learned value function 150 can serve as a cost function within a model predictive control (MPC) technique, enabling robust and safe robot grasping that generalizes to novel objects.

Although described herein primarily with respect to a single MLP 410 as a reference example, in some embodiments, an ensemble of MLPs that generate respective costs and associated confidence values can be used, in which case either only the costs associated with higher confidence values are used or the costs associated with higher confidence values can be weighted more. In other words, two variants are possible in some embodiments: (1) an ensemble of value functions to estimate epistemic uncertainty, and (2) a single value function for efficient inference. Ensembles improve robustness under distribution shifts by producing pessimistic costs that steer MPC away from uncertain regions, but the computational cost of ensembles can hinder real-time use. By contrast, a single value function enables fast inference suitable for real-world deployment. To improve performance on small datasets, a large-scale synthetic trajectory dataset can be used during training of the ensemble of MLPs or single MLP. Such a design reflects a trade-off: ensembles offer robustness through uncertainty estimation, while single models support real-time control given sufficient data coverage.

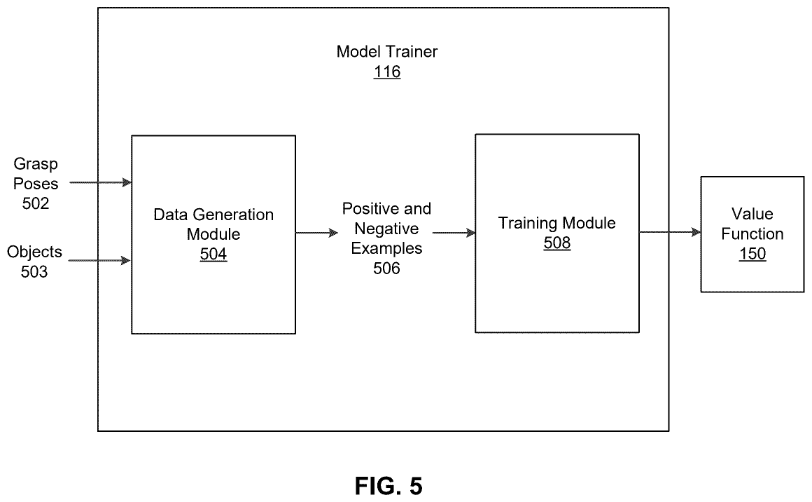

FIG. 5 is a more detailed illustration of the model trainer 116 of FIG. 1, according to various embodiments. As shown, the model trainer 116 includes, without limitation, a data generation module 504 and a training module 508. In operation, the model trainer 116 receives grasp poses 502 and objects 503 as input. The grasp poses 502 are robot poses (e.g., gripper poses) for grasping various objects 503. The objects 503 can be represented in any technically feasible manner, such as with point clouds. The data generation module 504 uses the grasp poses 502 and objects 503 to generate positive and negative examples 506, which the training module 508 uses as training data to train the value function 150. In some embodiments, the data generation module 504 generates the positive and negative examples 506 by (1) generating motion plans (also referred to herein as “action trajectories” or simply “trajectories”) for grasping objects based on the grasp poses 502, and (2) executing the motion plans in simulation to determine positive examples where an object was successfully grasped and negative examples where an object was not successfully grasped.

More specifically, the data generation module 504 can generate the positive and negative examples 506 as follows. First, the data generation module 504 can generate a diverse set of grasp trajectories using a number of different objects 503 (e.g., thousands of objects from the Objaverse data set). The trajectories can begin from pre-grasp poses, estimated using another grasp pose prediction model, which provides a rough estimate of viable grasp poses. Accordingly, each trajectory is generated to move from a pre-grasp pose to the corresponding ground-truth grasp pose. As a specific example, grasp pose annotations could be from the GraspGen dataset, and poses could be generated via antipodal sampling and verified for physical feasibility. In such cases, pre-grasp poses can be derived by applying a fixed offset (e.g., a 15 cm) from each annotated grasp pose. To increase data coverage, a random translation noise sampled from [symbol] (−0.04 cm, 0.04 cm) and orientation noise from [symbol] (−0.04π, 0.04π) can be added. Trajectories from the perturbed pre-grasp poses to the grasp poses can be generated via motion planning in a no-physics simulated environment, leveraging the verified feasibility of the targets. Doing so accelerates data collection by eliminating the need for physics simulation. The data generation module 504 can label trajectories that reach physically feasible grasp poses successfully, and leveraging both successful and failed cases enables the value function to learn grasp success likelihoods. In some embodiments, up to 256 trajectories are collected per object, with early termination if motion planning repeatedly fails. Each sample includes object poses

$${T}_{world}^{obj}$$

and end-effector poses

$${T}_{world}^{EE} .$$

In some embodiments, a large number of trajectories (e.g. millions of trajectories averaging tens of steps per trajectory) can be collected.

The value function(s) (e.g., value function 150) take as input a segmented object point cloud and the end-effector pose relative to the point cloud centroid,

$${T}_{obj}^{EE} .$$

To standardize inputs, the point cloud can be centered by subtracting a mean of the point cloud. Such a setup enables generalizability across the workspace using only local information. The data generation module 504 can label the collected trajectories with sparse costs, such as with terminal and near-terminal states in successful grasp trajectories labeled as 0, and all others as 1. In some embodiments, the cost cₜ as timestep t is defined as:

$${c}_{t} = \{ \begin{matrix}0 & \vert {q}_{goaal , i} - {q}_{t , i} \vert \leq 5 {e}^{- 3} , ∀ i , and {𝕝}_{valid} = 1 , \\ 1 & Otherwise\end{matrix} \qquad ( 1 )$$

where q_{t,i} and q_{goal,i} are the i-th joint positions at time t and the goal, respectively, and [symbol] _{valid} indicates whether the trajectory corresponds to a valid grasp. Accordingly, the data generation module 504 can generate, via simulations, training data that includes (1) robot states (e.g., gripper poses) with respect to object point clouds at different time steps of the sampled trajectories, (2) the object point clouds, and (3) corresponding cost-to-go labels ranging from 0 to 1 that are computed based on whether the trajectories were successful (and received a label of 0) or unsuccessful (and received a label of 1) and a distance from the last time step, according to equation (1).

A value function V(xₜ), such as the value function 150, can then be trained to approximate the expected cost-to-go, defined as V(xₜ)= [symbol] _{τ}[J(τ)]. To capture epistemic uncertainty, the training module 508 can train an ensemble of K value functions V_{φ}_{₁}, . . . , V_{φ}_{_{K}}, each initialized independently. K=1 implies a standard single value function. For K>1, the ensemble of value functions can provide uncertainty-aware estimates. In some embodiments, the value function(s) are trained using the Bellman error objective:

$${ϕ}_{k}^{*} = {arg min}_{ϕ} {𝔼}_{( x , c , {x}^{′} )} [ {( {c}_{t} + γ {V}_{{ϕ}_{k}^{′}} ( {x}^{′} ) - {V}_{{ϕ}_{k}} ( x ) )}^{2} ] , \qquad ( 2 )$$

where

$${V}_{{ϕ}^{′}}^{k} ( {x}^{′} )$$

denoted a k-th target value function with exponential moving average of parameters

$${ϕ}_{k}^{′} .$$

With an ensemble (K>1), aggregated predictions estimate epistemic uncertainty, enabling a pessimistic cost function, which is useful when fine-tuning on limited demonstrations, where state coverage is sparse. Such a conservative approach helps avoid overestimation and improves performance on novel objects. In contrast, a single value function (K=1) favors efficiency, relying on a large dataset to ensure adequate generalization.

Although described herein primarily with respect to training value function 150, in some embodiments, value function 150 can also be fine tuned after training. For example, additional data can be generated and used to fine tune value function 150 to perform grasping of a particular object within an environment (or another task).

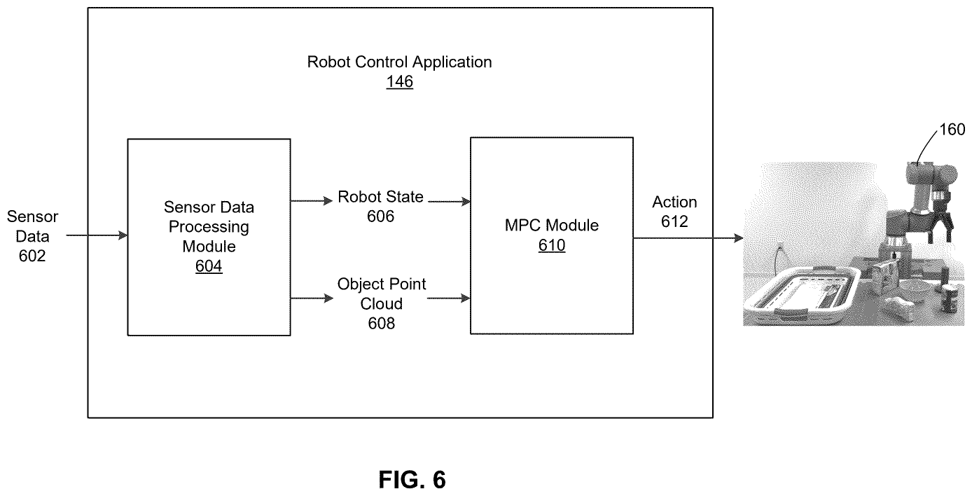

FIG. 6 is a more detailed illustration of the robot control application 146 of FIG. 1, according to various embodiments. As shown, the robot control application 146 includes, without limitation, a sensor data processing module 604 and a model predictive control (MPC) module 610. In operation, the robot control application 146 receives sensor data 602 as input. The sensor data processing module 604 processes the sensor data to generate a robot state 606 and an object point cloud 608. The robot state 606 and the object point cloud 608 can be obtained from the sensor data 602 in any technically feasible manner in some embodiments. For example, in some embodiments, the sensor data 602 can include joint angles of the robot 160, from which the sensor data processing module 604 can compute a pose of a gripper of the robot 160 using forward kinematics. In some embodiments, the sensor data 602 can include RGB-D (red, green, blue, depth) data of an environment surrounding the robot 160, and the sensor data processing module 604 can perform semantic segmentation on the RGB-D data and then extracting depths corresponding to a particular object identified through the semantic segmentation to create the object point cloud 608

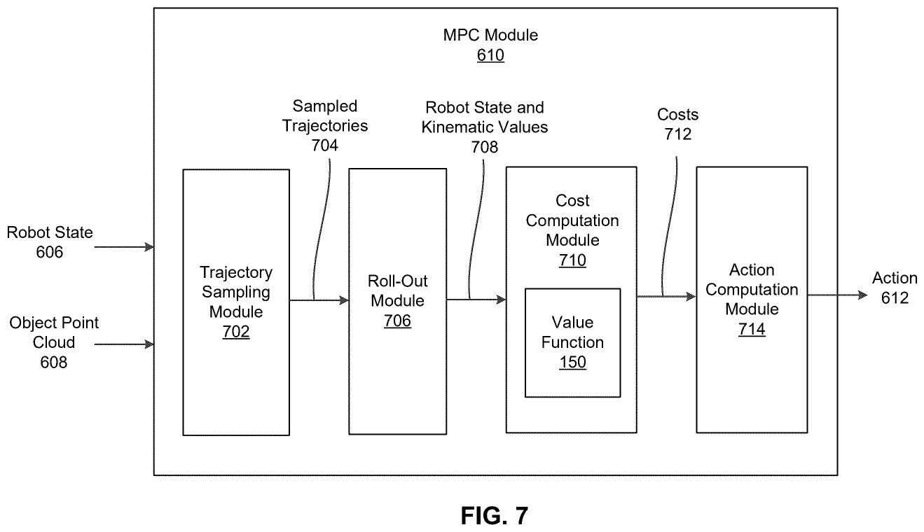

The MPC module 610 takes the robot state 606 and the object point cloud 608 as inputs and generates an action 612 for the robot 160 to perform. In some embodiments, the action 612 can include joint accelerations for a time step. The MPC module 610 performs an MPC technique that includes using the value function 150 to compute a cost, as discussed in greater detail below in conjunction with FIG. 7. The MPC technique samples action sequences and plans future states to select a next action that minimizes cost in real time given a dynamics model. The MPC technique is assumed to have access to a sufficiently accurate robot dynamics model, enabling prediction of end-effector states from applied control inputs. The MPC module 610 outputs the action 612 that can be executed by the robot 160. The foregoing process can be repeated to generate successive actions until the robot 160 is in position to grasp the object.

Although described herein primarily with respect to grasping as a reference example, techniques disclosed herein can be used to control a robot to perform any suitable task for which demonstration data is available to train the value function 150. Examples of other tasks include inserting an object into another object, opening a door, etc.

In some embodiments, the MPC module 610 performs grasp prediction and motion planning to enable grasping in cluttered scenes. In some embodiments, the grasp prediction and motion planning pipeline can include: (1) predicting grasp and pre-grasp poses using a fixed offset and filtering out in-collision poses via inverse kinematics; (2) planning a trajectory to a collision-free pre-grasp pose; and (3) executing actions from the pre-grasp to grasp the object using the sensor data processing module 504 and the MPC module 610, according to techniques disclosed herein.

In some embodiments, the robot control application 146 can also perform an open-loop grasp pose prediction model and motion planning technique. In such cases, the grasp prediction model generates grasp and pre-grasp poses for the target object. Feasible, collision-free pre-grasp poses are verified via inverse kinematics, and the robot moves to the selected pre-grasp pose using a motion planner. Once positioned, the robot control application 146 can perform grasping according to techniques disclosed herein.

FIG. 7 is a more detailed illustration of the MPC module 610 of FIG. 6, according to various embodiments. As shown, the MPC module 610 includes, without limitation, a trajectory sampling module 702, a roll-out module 706, a cost computation module 710, and an action computation module 714. The cost computation module 710 includes, without limitation, the value function 150.

In operation, the MPC module 610 takes the robot state 606 and the object point cloud 608 as inputs, and the MPC module 610 generates the action 612. The trajectory sampling module 702 samples a number of random trajectories beginning from the robot state 606, shown as sampled trajectories 704. The trajectories can be sampled by sampling actions that are joint accelerations over multiple time steps, forming action trajectories over time. In some embodiments, the actions can be sampled from the current best mean, such as by sampling random values and performing a Gaussian projection. The roll-out module 706 computes a robot state and kinematic values 708 for each time step of the sampled trajectories 704. The cost computation module 710 computes a cost of each sampled trajectory, shown as costs 712, based on the robot state and kinematic values for time steps of the sampled trajectory. The action computation module 714 computes a weighted average of the sampled trajectories 704 based on the costs 712. Then, the action computation module 714 selects joint accelerations at a first time step of the weighted average of the sampled trajectories 704 as the action 612.

More specifically, in some embodiments, the MPC module 610 uses one or more learned value functions, such as value function 150, as cost(s) to guide MPC in minimizing grasping cost during deployment. The value function(s) approximate the expected cost-to-go, which are integrated into the MPC objective to select control inputs. However, MPC may sample out-of-distribution actions, leading to unreliable cost estimates and reduced performance. To mitigate such an issue, MPC can be constrained using pessimistic upper bounds to avoid unsupported states. In that regard, in some embodiments, the MPC can use a risk-averse objective:

$${C}_{grasp} ( {x}_{h ∈ H} , {\ddot{a}}_{h ∈ H} ) = log ( {\sum }_{1}^{k} exp ( \frac{1}{λ} {G}_{i} ( {x}_{h ∈ H} , {\ddot{a}}_{h ∈ H} ) ) ) , \qquad ( 3 )$$

where

$${G}_{i} ( {x}_{h ∈ H} , {\ddot{a}}_{h ∈ H} ) = {\sum }_{{t}^{′} = t}^{t + H} {γ}^{{t}^{′} - t} {V}_{θ , i} ( {x}_{{t}^{′}} )$$

and ä is an acceleration control input for MPC. Intuitively, such an objective allows MPC to assign lower weights to trajectories that lead to uncertain regions where an ensemble of values exhibits greater disagreement, with A serving as a hyperparameter to control the level of pessimism. Such a pessimistic estimate is calculated exclusively at the initial state xₜ rather than at every intermediate state in MPC rollouts, as the latter approach can introduce an over-pessimistic bias. When using only a single value function (K=1), the above formulation simplifies to C_{grasp} (x_{h∈H}, ä_{h∈H})=G(x_{h∈H}, ä_{h∈H}).

In some embodiments, other MPC costs (e.g., minimum jerk, collision) are augmented with a value-based grasp cost generated by the value function(s) (e.g., value function 150). The final cost can be defined as:

$${C}_{Grasp - MPC} = {C}_{default} + ω {X}_{grasp} , \qquad ( 4 )$$

where C_{default} is a set of default costs, such as a cost that penalizes collisions of the robot with the environment, a cost that penalizes self-collisions, a cost that penalizes large joint accelerations, a cost based on joint limits, and/or the like, and @ is a weight for the pessimistic cost function.

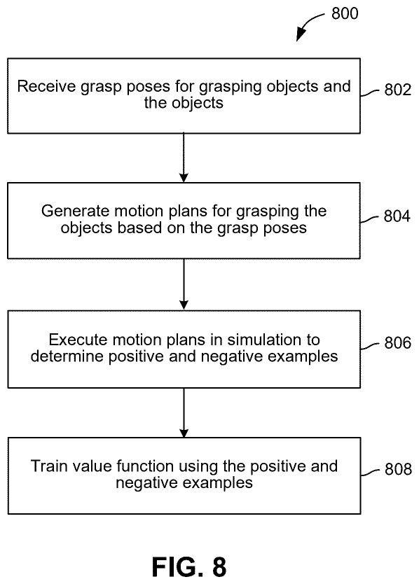

FIG. 8 is a flow diagram of method steps for training a value function, according to various embodiments. Although the method steps are described in conjunction with the systems of FIGS. 1-7, persons skilled in the art will understand that any system configured to perform the method steps in any order falls within the scope of the present embodiments.

As shown, a method 800 begins at step 802, where the model trainer 116 receives grasp poses for grasping objects and the objects. A number of grasp poses for grasping a number of different objects can be received, and the objects can be represented in any technically feasible manner (e.g., as point clouds), as described above in conjunction with FIG. 5.

At step 804, the model trainer 116 generates motion plans for grasping objects based on the grasp poses. In some embodiments, the motion plans can include trajectories beginning from pre-grasp poses, estimated using another grasp pose prediction model, which provides a rough estimate of viable grasp poses. Accordingly, each trajectory is generated to move from a pre-grasp pose to the corresponding ground-truth grasp pose. To increase data coverage, a random translation noise can be added. Trajectories from the perturbed pre-grasp poses to the grasp poses can be generated via motion planning in a no-physics simulated environment, leveraging the verified feasibility of the targets, as described above in conjunction with FIG. 5.

At step 806, the model trainer 116 executes the motion plans in simulation to determine positive and negative examples. As described above in conjunction with FIG. 5, the positive examples are examples in which grasping of an object was successful. The negative examples are examples in which grasping of an object was not successful. In some embodiments, the data generation module 504 of the model trainer 116 can label trajectories that reach physically feasible grasp poses successfully. Leveraging both successful and failed cases enables the value function to learn grasp success likelihoods. In some embodiments, a number (e.g., 256) of trajectories are collected per object, with early termination if motion planning repeatedly fails. In some embodiments, the data generation module 504 can generate, via simulations, training data that includes (1) robot states (e.g., gripper poses) with respect to object point clouds at different time steps of the sampled trajectories, (2) the object point clouds, and (3) corresponding cost-to-go labels ranging from 0 to 1 that are computed based on whether the trajectories were successful (and received a label of 0) or unsuccessful (and received a label of 1) and a distance from the last time step, according to equation (1).

At step 808, the model trainer 116 trains the value function 150 using the positive and negative examples. In some embodiments, one or more value functions are trained using the Bellman error objective

$$\begin{matrix}{ϕ}_{k}^{*} = {arg min}_{ϕ} {𝔼}_{( x , c , {x}^{′} )} [ ( {c}_{t} + γ {V}_{{ϕ}_{k}^{′}} ( {x}^{′} ) - \\ {{V}_{{ϕ}_{k}} ( x ) )}^{2} ] ,\end{matrix}$$

where

$${V}_{{ϕ}^{′}}^{k} ( {x}^{′} )$$

denotes a k-th target value function with exponential moving average of parameters

$${ϕ}_{k}^{′} ,$$

as described above in conjunction with FIG. 5.

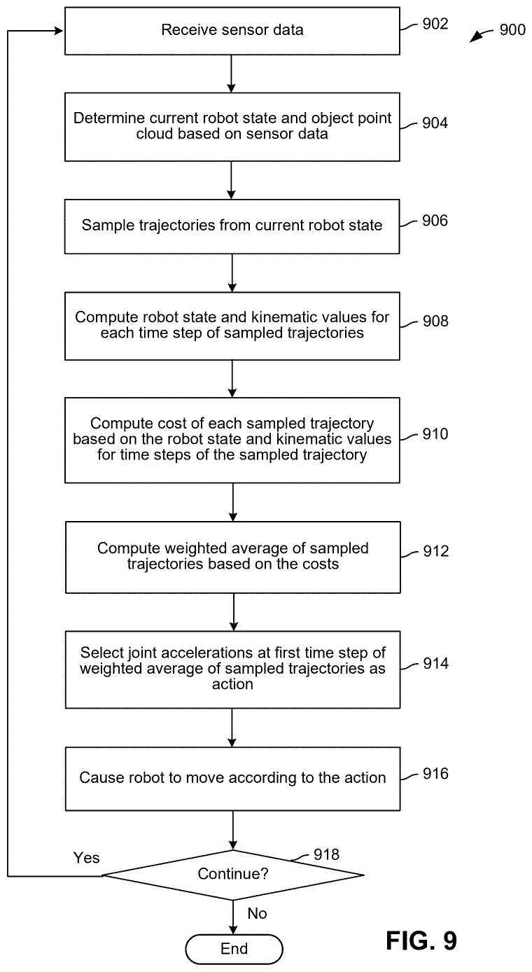

FIG. 9 is a flow diagram of method steps for controlling a robot, according to various embodiments. Although the method steps are described in conjunction with the systems of FIGS. 1-7, persons skilled in the art will understand that any system configured to perform the method steps in any order falls within the scope of the present embodiments.

As shown, a method 900 begins at step 902, where the robot control application 146 receives sensor data. In some embodiments, the sensor data can include segmentation on RGB-D (red, green, blue, depth) data and joint angle data, as described above in conjunction with FIGS. 4 and 6.

At step 904, the robot control application 146 determines a current robot state and an object point cloud based on the sensor data. As described above in conjunction with FIG. 6, in some embodiments, the sensor data processing module 604 of the robot control application 146 can perform semantic segmentation on the RGB-D data and then extracting depths corresponding to a particular object identified through the semantic segmentation to create the object point cloud. In addition, the sensor data processing module 604 can compute a pose of a gripper of the robot 160 from joint angle using forward kinematics.

At step 906, the robot control application 146 samples trajectories beginning from the current robot state. In some embodiments, the trajectories can be sampled by sampling actions that are joint accelerations over multiple time steps, forming action trajectories over time. In some embodiments, the actions can be sampled from the current best mean, such as by sampling random values and performing a Gaussian projection, as described above in conjunction with FIGS. 6-7.

At step 908, the robot control application 146 computes a robot state and kinematic values for each time step of the sampled trajectories. In some embodiments, the robot state and kinematic values at each time step can be computed from the sampled trajectories using known techniques.

At step 910, the robot control application 146 computes a cost of each sampled trajectory based on the robot state and kinematic values for time steps of the sampled trajectory. As described above in conjunction with FIG. 7, in some embodiments, the MPC module 610 uses one or more learned value functions, such as value function 150, as cost(s) to guide MPC in minimizing grasping cost during deployment. The value function(s) approximate the expected cost-to-go, which are integrated into the MPC objective to select control inputs. However, MPC may sample out-of-distribution actions, leading to unreliable cost estimates and reduced performance. To mitigate such an issue, MPC can be constrained using pessimistic upper bounds to avoid unsupported states. In that regard, in some embodiments, the MPC can use the risk-averse objective of equation (3). Such an objective allows MPC to assign lower weights to trajectories that lead to uncertain regions where an ensemble of values exhibits greater disagreement, with λ serving as a hyperparameter to control the level of pessimism. Such a pessimistic estimate is calculated exclusively at the initial state xₜ rather than at every intermediate state in MPC rollouts, as the latter approach can introduce an over-pessimistic bias. When using only a single value function (K=1), the above formulation simplifies to C_{grasp} (x_{h∈H}, ä_{h∈H})=G(x_{h∈H}, ä_{h∈H}).

In some embodiments, other MPC costs (e.g., minimum jerk, collision) are augmented with a value-based grasp cost generated by the value function(s) (e.g., value function 150). The final cost can then be computed according to equation (4), as described above in conjunction with FIG. 7.

At step 912, the robot control application 146 computes a weighted average of sampled trajectories based on the costs. In some embodiments, each sampled trajectory is weighted based on the associated cost computed at step 910, as described above in conjunction with FIG. 7.

At step 914, the robot control application 146 selects joint accelerations at a first time step of the weighted average of sampled trajectories as an action. In some embodiments, only the first time step of the weighted average of sampled trajectories is executed by a robot. In some other embodiments, more than one time step of the weighted average of sampled trajectories can be executed.

At step 916, the robot control application 146 causes the robot 160 to move according to the action. For example, the action can be transmitted to a robot joint controller, such as a proportional derivative (PD) controller, that yields joint torques in order to move joints of a robot to achieve the action.

At step 918, if the robot control application 146 determines to continue, then the method 900 returns to step 902, where the robot control application 146 receives additional sensor data. In some embodiments, the robot control application 146 can determine to continue until the robot 160 is in position to grasp the object (or perform another task), after which a gripper of the robot 160 can be controlled to grasp the object (or perform the other task).

In sum, techniques are disclosed for integrating learned value functions into model predictive control for robot grasping. In some embodiments, a value function is a trained machine learning model that includes an object representation encoder, an object state encoder, and an MLP. Given a point cloud representation of an object (“object point cloud”) and a robot state as input, the object representation encoder encodes the object point cloud to generate a latent representation of the object, and the object state encoder encodes the robot state to generate a latent representation of the robot state. The latent representation of the object and the latent representation of the robot state are concatenated together and then input into the MLP, which outputs a predicted cost-to-go. The predicted cost-to-go can be used to compute the cost of trajectories in a MPC technique that generates an action, and a robot can be controlled to perform the action. The foregoing process can be repeated to generate successive actions, until the robot is in position for grasping an object. The value function can be trained using training data that includes positive and negative examples that are generated by (1) generating motion plans for grasping objects based on known grasp poses, and (2) executing the motion plans in simulation to determine positive examples where an object was successfully grasped and negative examples where an object was not successfully grasped.

At least one technical advantage of the disclosed techniques relative to the prior art is that the disclosed techniques can control a robot to grasp an object while adapting to changes in real time, including movements of the object. The disclosed techniques also permit robots to grasp objects in cluttered environments. Another advantage is that the grasp planning according to the disclosed techniques is generalizable across different types of objects, allowing a robot to be controlled to grasp various objects. These technical advantages represent one or more technological improvements over prior art approaches.

The following clauses describe aspects of the various embodiments.

1. In some embodiments, a computer-implemented method for controlling a robot comprises computing, using a trained machine learning model and based on first sensor data, one or more first costs associated with one or more first trajectories, determining an action based on the one or more first costs, and controlling the robot to move based on the action.

2. The computer-implemented method of clause 1, wherein the trained machine learning model comprises a first encoder configured to encode a representation of an object determined based on the first sensor data into a first latent representation, a second encoder that encodes a state of the robot determined based on the first sensor data into a second latent representation, and a neural network that processes the first latent representation and the second latent representation to generate a cost included in the one or more first costs.

3. The computer-implemented method of clauses 1 or 2, further comprising generating the representation of the object based on a semantic segmentation of RGB-D (red, green, blue, depth) data included in the first sensor data.

4. The computer-implemented method of any of clauses 1-3, wherein the state of the robot comprises a pose of a gripper of the robot.

5. The computer-implemented method of any of clauses 1-4, wherein determining the action comprises computing a weighted average of the one or more first trajectories based on the one or more first costs, and selecting one or more joint accelerations at a first time step included in the weighted average of the one or more first trajectories as the action.

6. The computer-implemented method of any of clauses 1-5, further comprising computing one or more second costs based on one or more collisions during the one or more first trajectories, wherein the action is further determined based on the one or more second costs.

7. The computer-implemented method of any of clauses 1-6, further comprising computing one or more second costs based on accelerations of one or more joints of the robot during the one or more first trajectories, wherein the action is further determined based on the one or more second costs.

8. The computer-implemented method of any of clauses 1-7, further comprising sampling the one or more first trajectories, wherein each trajectory included in the one or more first trajectories begins from a state of the robot.

9. The computer-implemented method of any of clauses 1-8, wherein the trained machine learning model comprises an ensemble of machine learning models that generate respective costs and associated confidence values.

10. The computer-implemented method of any of clauses 1-9, further comprising generating one or more motion plans for grasping one or more objects based on one or more grasp poses, simulating the one or more motion plans to determine one or more positive examples that result in successful grasps and one or more negative examples that result in unsuccessful grasps, and training an untrained machine learning model based on the one or more positive examples and the one or more negative examples to generate the trained machine learning model.

11. In some embodiments, one or more non-transitory computer-readable media store instructions that, when executed by at least one processor, cause the at least one processor to perform the steps of computing, using a trained machine learning model and based on first sensor data, one or more first costs associated with one or more first trajectories, determining an action based on the one or more first costs, and controlling a robot to move based on the action.

12. The one or more non-transitory computer-readable media of clause 11, wherein the trained machine learning model comprises a first encoder configured to encode a representation of an object determined based on the first sensor data into a first latent representation, a second encoder that encodes a state of the robot determined based on the first sensor data into a second latent representation, and a neural network that processes the first latent representation and the second latent representation to generate a cost included in the one or more first costs.

13. The one or more non-transitory computer-readable media of clauses 11 or 12, wherein the instructions, when executed by the at least one processor, further cause the at least one processor to perform the step of generating the representation of the object based on a semantic segmentation of RGB-D (red, green, blue, depth) data included in the first sensor data.

14. The one or more non-transitory computer-readable media of any of clauses 11-13, wherein determining the action comprises computing a weighted average of the one or more first trajectories based on the one or more first costs, and selecting one or more joint accelerations at a first time step included in the weighted average of the one or more first trajectories as the action.

15. The one or more non-transitory computer-readable media of any of clauses 11-14, wherein the instructions, when executed by the at least one processor, further cause the at least one processor to perform the step of computing one or more second costs based on at least one of one or more collisions or accelerations of one or more joints of the robot during the one or more first trajectories, wherein the action is further determined based on the one or more second costs.

16. The one or more non-transitory computer-readable media of any of clauses 11-15, wherein the instructions, when executed by the at least one processor, further cause the at least one processor to perform the step of determining a state of the robot based on the first sensor data, wherein the one or more first costs are computed further based on the state of the robot.

17. The one or more non-transitory computer-readable media of any of clauses 11-16, wherein the instructions, when executed by the at least one processor, further cause the at least one processor to perform the step of sampling the one or more first trajectories, wherein each trajectory included in the one or more first trajectories begins from a state of the robot.

18. The one or more non-transitory computer-readable media of any of clauses 11-17, wherein the one or more first trajectories are sampled randomly.

19. The one or more non-transitory computer-readable media of any of clauses 11-18, wherein the instructions, when executed by the at least one processor, further cause the at least one processor to perform the step of training an untrained machine learning model based on one or more positive examples and one or more negative examples to generate the trained machine learning model.

20. In some embodiments, a system comprises one or more memories storing instructions, and one or more processors that are coupled to the one or more memories and, when executing the instructions, are configured to compute, using a trained machine learning model and based on sensor data, one or more costs associated with one or more trajectories, determine an action based on the one or more costs, and control a robot to move based on the action.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a robot, the method comprising:
computing, using a trained machine learning model and based on first sensor data, one or more first costs associated with one or more first trajectories;
determining an action based on the one or more first costs; and
controlling the robot to move based on the action.

2. The computer-implemented method of claim 1, wherein the trained machine learning model comprises:
a first encoder configured to encode a representation of an object determined based on the first sensor data into a first latent representation;
a second encoder that encodes a state of the robot determined based on the first sensor data into a second latent representation; and
a neural network that processes the first latent representation and the second latent representation to generate a cost included in the one or more first costs.

3. The computer-implemented method of claim 2, further comprising generating the representation of the object based on a semantic segmentation of RGB-D (red, green, blue, depth) data included in the first sensor data.

4. The computer-implemented method of claim 2, wherein the state of the robot comprises a pose of a gripper of the robot.

5. The computer-implemented method of claim 1, wherein determining the action comprises:
computing a weighted average of the one or more first trajectories based on the one or more first costs; and
selecting one or more joint accelerations at a first time step included in the weighted average of the one or more first trajectories as the action.

6. The computer-implemented method of claim 1, further comprising computing one or more second costs based on one or more collisions during the one or more first trajectories, wherein the action is further determined based on the one or more second costs.

7. The computer-implemented method of claim 1, further comprising computing one or more second costs based on accelerations of one or more joints of the robot during the one or more first trajectories, wherein the action is further determined based on the one or more second costs.

8. The computer-implemented method of claim 1, further comprising sampling the one or more first trajectories, wherein each trajectory included in the one or more first trajectories begins from a state of the robot.

9. The computer-implemented method of claim 1, wherein the trained machine learning model comprises an ensemble of machine learning models that generate respective costs and associated confidence values.

10. The computer-implemented method of claim 1, further comprising:
generating one or more motion plans for grasping one or more objects based on one or more grasp poses;
simulating the one or more motion plans to determine one or more positive examples that result in successful grasps and one or more negative examples that result in unsuccessful grasps; and
training an untrained machine learning model based on the one or more positive examples and the one or more negative examples to generate the trained machine learning model.

11. One or more non-transitory computer-readable media storing instructions that, when executed by at least one processor, cause the at least one processor to perform the steps of:
computing, using a trained machine learning model and based on first sensor data, one or more first costs associated with one or more first trajectories;
determining an action based on the one or more first costs; and
controlling a robot to move based on the action.

12. The one or more non-transitory computer-readable media of claim 11, wherein the trained machine learning model comprises:
a first encoder configured to encode a representation of an object determined based on the first sensor data into a first latent representation;
a second encoder that encodes a state of the robot determined based on the first sensor data into a second latent representation; and
a neural network that processes the first latent representation and the second latent representation to generate a cost included in the one or more first costs.

13. The one or more non-transitory computer-readable media of claim 12, wherein the instructions, when executed by the at least one processor, further cause the at least one processor to perform the step of generating the representation of the object based on a semantic segmentation of RGB-D (red, green, blue, depth) data included in the first sensor data.

14. The one or more non-transitory computer-readable media of claim 11, wherein determining the action comprises:
computing a weighted average of the one or more first trajectories based on the one or more first costs; and
selecting one or more joint accelerations at a first time step included in the weighted average of the one or more first trajectories as the action.

15. The one or more non-transitory computer-readable media of claim 11, wherein the instructions, when executed by the at least one processor, further cause the at least one processor to perform the step of computing one or more second costs based on at least one of one or more collisions or accelerations of one or more joints of the robot during the one or more first trajectories, wherein the action is further determined based on the one or more second costs.

16. The one or more non-transitory computer-readable media of claim 11, wherein the instructions, when executed by the at least one processor, further cause the at least one processor to perform the step of determining a state of the robot based on the first sensor data, wherein the one or more first costs are computed further based on the state of the robot.

17. The one or more non-transitory computer-readable media of claim 11, wherein the instructions, when executed by the at least one processor, further cause the at least one processor to perform the step of sampling the one or more first trajectories, wherein each trajectory included in the one or more first trajectories begins from a state of the robot.

18. The one or more non-transitory computer-readable media of claim 11, wherein the one or more first trajectories are sampled randomly.

19. The one or more non-transitory computer-readable media of claim 11, wherein the instructions, when executed by the at least one processor, further cause the at least one processor to perform the step of training an untrained machine learning model based on one or more positive examples and one or more negative examples to generate the trained machine learning model.

20. A system, comprising:
one or more memories storing instructions; and
one or more processors that are coupled to the one or more memories and, when executing the instructions, are configured to:
compute, using a trained machine learning model and based on sensor data, one or more costs associated with one or more trajectories,
determine an action based on the one or more costs, and
control a robot to move based on the action.
